(19) United States
(12) Patent Application Publication
(10) Pub. No.: US 2026/0281008 A1
(43) Pub. Date: Sep. 17, 2026

(54) Network Application Programming Interface (API) Call Optimization with Network Analytics

(71) Applicant: Telefonaktiebolaget LM Ericsson (publ), Stockholm (SE)

(72) Inventors: Géza Szabó, Kecskemét (HU); Áron Dénes Szabó, Budapest (HU); Attila Báder, Paty (HU)

(21) Appl. No.: 19/471,486

(22) PCT Filed: Apr. 13, 2023
(86) PCT No.: PCT/IB2023/053790

§ 371 Date: Oct. 1, 2025

(51) Int. Cl. H04L 41/5009; G06F 9/54

(52) U.S. Cl. CPC H04L 41/5009; G06F 9/547

(57) ABSTRACT

A network node (210) optimizes network exposure Application Programming Interfaces (APIs). The network node monitors and obtains Key Performance Indicators (KPIs) for different networks and devices on a per-flow basis, as well as the network exposure APIs having functions invoked by an application program. Based on the call sequences and parameters in the APIs (212), the network node categorizes the APIs into clusters (214). Each API in a given cluster yields the same or similar results and KPI values when used by the application program. Then, from these clusters, the network node generates optimized network exposure APIs (144) that can be integrated into and/or called by application programs. The optimized network exposure APIs are also used as a curriculum in a reinforcement learning process to train the network node to use the optimized network exposure APIs in an optimized manner according to a Service Level Agreement (SLA).

### TECHNICAL FIELD

This application is generally related to network analytics and network management, and more particularly to techniques for training and generating application programming interfaces (APIs) that expose network functionality.

### BACKGROUND

The Network Data Analytics Function (NWDAF) is a core network function defined by the Third Generation Partnership Project (3GPP). Particularly, the NWDAF collects data for various analytics functions and supports the automated operation of mobile networks. To accomplish its goals, the NWDAF incorporates standard interfaces to collect the data from other core network nodes and functions, as well as from Operations, Administration and Maintenance (OAM) systems and a variety of cloud, edge, and/or other external data sources. Generally, the NWDAF is configured to implement various analytics policies and rule-based or machine learning (ML) based algorithms to support a variety of network functions such as service orchestration and automated network configuration and operation. Additionally, the NWDAF supports subscription-based and request/response type analytics functions, as well as closed loop optimization features using a policy control function (PCF).

### SUMMARY

Embodiments of the present disclosure provide an action-space growing Artificial Intelligence (AI) approach to optimize application of network exposure APIs according to various key performance indicators (KPIs). Additionally, the present embodiments provide an AI-based clustering method that prepares the sets of network exposure APIs for optimization.

Accordingly, in a first aspect, the present disclosure provides a method, implemented in a network node, for optimizing network exposure Application Programming Interfaces (APIs). In this aspect, the method calls for obtaining a set of network APIs, wherein each network API is configured to expose one or more network functions to an application program, clustering the set of network APIs into a set of API call clusters based on call sequences and parameter sets in the set of network APIs, and generating one or more optimized network APIs from the set of API call clusters based on one or more target Key Performance Indicators (KPIs), wherein each optimized network API comprises an optimized API call sequence.

A second aspect of the present disclosure provides a network node comprising processing circuitry and memory circuitry. The memory circuitry is configured to store instructions executable by the processing circuitry that, when executed, configure the network node to obtain a set of network APIs, wherein each network API is configured to expose one or more network functions to an application program, cluster the set of network APIs into a set of API call clusters based on call sequences and parameter sets in the set of network APIs, and generate one or more optimized network APIs from the set of API call clusters based on one or more target Key Performance Indicators (KPIs), wherein each optimized network API comprises an optimized API call sequence.

In a third aspect, the present disclosure provides a network node for optimizing network exposure Application Programming Interfaces (APIs). In these embodiments, the network node is configured to obtain a set of network APIs, wherein each network API is configured to expose one or more network functions to an application program, cluster the set of network APIs into a set of API call clusters based on call sequences and parameter sets in the set of network APIs, and generate one or more optimized network APIs from the set of API call clusters based on one or more target Key Performance Indicators (KPIs), wherein each optimized network API comprises an optimized API call sequence.

In a fourth aspect, the present disclosure provides a computer program comprising instructions that, when executed on processing circuitry of a network node, cause the network node to obtain a set of network APIs, wherein each network API is configured to expose one or more network functions to an application program, cluster the set of network APIs into a set of API call clusters based on call sequences and parameter sets in the set of network APIs, and generate one or more optimized network APIs from the set of API call clusters based on one or more target Key Performance Indicators (KPIs), wherein each optimized network API comprises an optimized API call sequence.

In a fifth aspect, the present disclosure provides a carrier containing the computer program of the fourth aspect, wherein the carrier is one of an electronic signal, optical signal, radio signal, or computer readable storage medium.

In a sixth aspect, the present disclosure provides a non-transitory computer-readable storage medium comprising a computer program stored thereon. The computer program comprises executable instructions that, when executed by processing circuitry in a network node, causes the network node to obtain a set of network APIs, wherein each network API is configured to expose one or more network functions to an application program, cluster the set of network APIs into a set of API call clusters based on call sequences and parameter sets in the set of network APIs, and generate one or more optimized network APIs from the set of API call clusters based on one or more target Key Performance Indicators (KPIs), wherein each optimized network API comprises an optimized API call sequence.

### BRIEF DESCRIPTION OF THE DRAWINGS

FIG. 1 illustrates an on-network functional model for network resource management.

FIG. 2 illustrates an exemplary architecture of a 3GPP TSG SA WG6 (SA6) layer.

FIG. 3 is a signaling diagram illustrating a call flow for a resource request for establishing communications for a Vertical Application Layer (VAL) service.

FIG. 4 is a functional block diagram illustrating an exemplary architecture for a network configured according to embodiments of the present disclosure.

FIGS. 5A-5B illustrates a table mapping some example network features to different network exposure APIs configured to provide access to those network features.

FIG. 6 is a functional block diagram illustrating some exemplary pre-processing functions for growing an action space according to embodiments of the present disclosure.

FIGS. 7A-7B are functional block diagrams illustrating an exemplary machine learning (ML) function according to embodiments of the present disclosure.

FIG. 7C illustrates example code for handling protocol response codes according to one embodiment of the present disclosure.

FIG. 8 is a flow diagram illustrating an exemplary method for monitoring service and resource Key Performance Indicators (KPIs), and for using those KPIs in a ML process to train and optimize the APIs that expose network functionality according to embodiments of the present disclosure.

FIG. 9 is a flow diagram illustrating a method for optimizing network exposure APIs according to embodiments of the present disclosure.

FIG. 10 is a functional block diagram illustrating a network node configured to optimize network exposure APIs according to embodiments of the present disclosure.

FIG. 11 shows an example of a communication system in accordance with some embodiments of the present disclosure.

FIG. 12 is a block diagram of a host in accordance with various aspects described herein.

FIG. 13 shows a communication diagram of a host communicating via a network node with a UE over a partially wireless connection in accordance with some embodiments of the present disclosure.

### DETAILED DESCRIPTION

The Network Data Analytics Function (NWDAF) is a core network function defined by the 3GPP for 5G networks that streamlines the way in which network data is produced and consumed. In particular, the NWDAF is configured to collect data, perform analytics functions, and provide insight into the way a network and/or a service provided by the network is functioning. The presence and use of an NWDAF within the core network, therefore, is advantageous in a variety of different scenarios. Such scenarios include, but are not limited to, those associated with:
Service quality, service experience, and Service Level Agreement (SLA) monitoring and assurance;
Detecting and solving network performance issues;
Predicting network conditions and proactively adapting network operations to those conditions;
Maximizing the return on network capacity investments;
Optimizing the use and availability of network resources;
Network load performance monitoring analytics and load prediction;
Network slice assurance;
Service quality monitoring of subs groups;
Detection of abnormal behavior and anomalies in the network and/or with network services;
Mobility-related information and prediction; and
Congestion control.
   Of course, other scenarios and use cases may exist in which the NWDAF can play a prominent role.

There are a variety of advanced analytics systems for supporting NWDAF functionalities. Most conventional systems are based on collecting and correlating elementary network events from different network domains, such as the core, radio, and transport networks. Generally, such “session-based” systems calculate “end-to-end” (e2e) service quality metrics (S-KPIs), as well as radio and network resource metrics (R-KPIs) for a session. These collected metrics will typically cover session setup, service usage, and session termination phases, and may be used to characterize the radio environment and/or network operation at the session level. These types of conventional solutions are usually suitable for session-based troubleshooting and analysis of network issues.

Event-based analytics, however, requires the real-time collection and correlation of characteristic node and protocol events from different radio and core network nodes. It also requires the probing of signaling interfaces (IFs) and the sampling of user-plane traffic. In addition to these data collection and correlation functions, though, event-based analytics systems also provide a variety of different analytics functions, advanced database capabilities, rule engines, and an Artificial Intelligence (AI) framework that allows the execution and training of machine learning (ML) models to support closed loop operations.

In view of their introduction, 5G mobile networks are expected to serve a large variety of new services, as well as provide quality of service (QoS)/quality of experience (QoE) for those services. Further, 5G mobile networks are expected to handle a variety of new network deployment scenarios, such as those related to the deployment and use of industrial applications on private networks. Additionally, there are a variety of coexisting network exposure capabilities made available to different services via various network exposure APIs. Using these network exposure APIs, different network functions, such as a Network Exposure Function (NEF) and/or a Service Enable Architecture Layer (SEAL) function can make direct requests to, and receive responses from, a Policy Control Function (PCF).

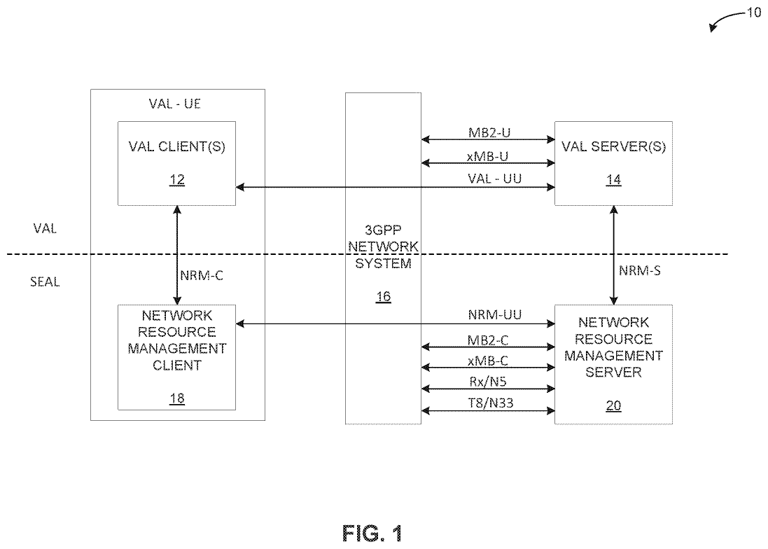

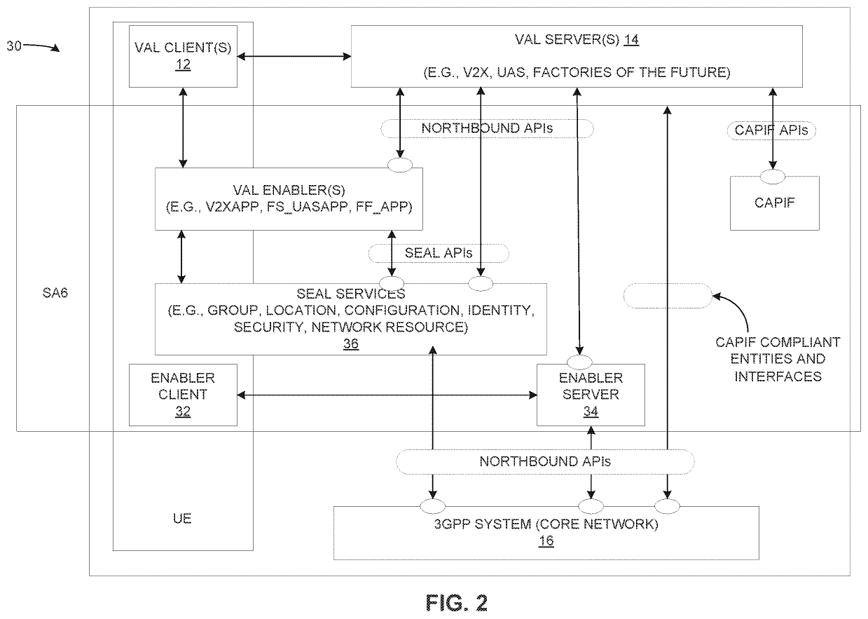

By way of example only, FIG. 1 illustrates an on-network functional model 10 for SEAL-based network resource management. FIG. 2 illustrates an architecture 30 for providing 3GPP SA6 Mission Critical services. With reference to these figures, a typical workflow for a network exposure API call in a 3GPP SA6 service begins with an application developer of either a vertical application layer (VAL) client 12 or VAL server 14 initiating an API (e.g., an HTTP call) call towards a SEAL service provider, for example. The API call flow then follows one of two routes. First, the API call flow can go to a SEAL enabler client 32 (FIG. 2) prior to going to a SEAL enabler server 34, or the API call flow can go directly to a SEAL enabler server 34. Regardless, the API call flow typically triggers the performance of an action towards the 5G core network 40 and responds to either the VAL client 12 or the VAL server 14, accordingly.

The 3GPP Technical Specification TS 23.434 v.18.3.0 (2022-12), which is incorporated herein by reference in its entirety, provides a more detailed description of this procedure in clause 14.2.2.1. More specifically, a network resource management client 18 (seen in FIG. 1) communicates with the network resource management server 20 over the NRM-UU reference point. The network resource management client 18 provides the support for network resource management functions to the VAL client(s) 12 over an NRM-C reference point. The VAL server(s) 14 communicates with the network resource management server 20 via a NRM-S reference point.

The network resource management server 20 communicates with various entities in the underlying 3GPP network system 16. For example, the network resource management server 20 communicates with a Broadcast Multicast Service Center (BM-SC) (not shown) via the MB2-C and xMB-C reference points to obtain and control the multicast resources from the underlying 3GPP network system 16. The network resource management server 20 also communicates with a Policy Control and Charging Rules Function (PCRF) (not shown) in the underlying 3GPP network system 16 via an Rx reference point, and with a PCF via the N5 reference point to control unicast resources from the underlying 3GPP network system 16. The network resource management server 20 further communicates with a Service Capability Exposure Function (SCEF) (not shown) in the underlying 3GPP network system 16 via a T8 reference point, or with a Network Exposure Function (NEF) (not shown), in the underlying 3GPP network system 16 via a N33 reference point, to perform event monitoring procedures from the underlying 3GPP network system 16. The network resource management server 20 further interacts with the NEF in the underlying 3GPP network system 16 via an N33 reference point to obtain Quality of Service (QoS) monitoring information from the 3GPP network system 16.

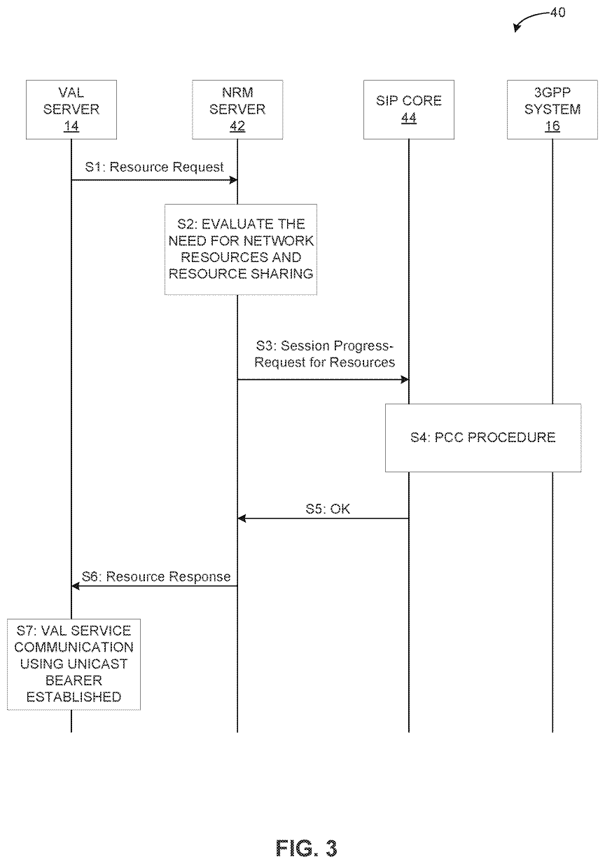

As an example, chapter 14.3.3.2.1.1 of TS 23.434 provides a unicast resource management with Session Initiation Protocol (SIP) core procedure for requesting unicast resources when establishing VAL service communication. Particularly, this procedure specifies how network resources are requested when establishing VAL service communication. Such resource requests include, for example, application type, bandwidth, priority, application identifier, and resource sharing information. If concurrent sessions are used, a Network Resource Model (NRM) server (seen in FIG. 3) may utilize its resource sharing capability for underlying network policy and charging functions.

FIG. 3 is a signaling diagram 40 illustrating a generic procedure that may be used when requesting resources in any type of session establishment. It should be noted here that the same procedure illustrated in FIG. 3 can also be found in chapter 14.3.3.2.1.2 and FIG. 14.3.3.2.1.2-1 of TS 23.434. Additionally, it is assumed in FIG. 3 that the VAL client 12 has already requested VAL service communication with the VAL server 14.

As seen in FIG. 3, VAL server 14 sends a request for resources to an NRM server 42 (S1). Upon receipt, the NRM server 42 evaluates the need for network resources and use of resource sharing (S2) before sending a session progress request message (S3) to a SIP core 44 (e.g., a local inbound/outbound proxy) requesting resources. The Policy and Charging Control (PCC) procedures (S4) are then initiated from the SIP core 44, which then returns an OK message (S5) to the NRM server 42. The NRM server 42, in turn, returns a resource response message (S6) to VAL server 14. So received, the VAL service communication has been established and resources have been allocated (S7).

Although useful, conventional methods of communication using network exposure APIs can be problematic. For example, in industrial applications, a customer (e.g., a manufacturing company) will typically use different types of devices produced by different vendors. However, these vendors may configure their device(s) to use different APIs/types of APIs to perform the same type of function. For example, consider resource requests, which usually target the same functionality (e.g., establishing a connection, providing a certain QoS, etc.). With conventional systems, the devices involved in the resource requests may use different APIs to achieve the same function. However, due to the number of different APIs that are available (and used), it is difficult to ensure that consistent resource requests are communicated to the network. Further, there are too many different APIs to handle and/or manage manually, and there is no efficient method available with which to select an API for use in a given situation. In addition, each API may have many parameters. While some parameters may be the same across APIs, many have to be provided by developers and/or the administrators of the APIs. This, however, requires a developer integrating the APIs into an application program to manually attend to all the different parameters. Such manual processes, however, are very time consuming and increase the risk for introducing errors.

Besides the NRM functions, other functions provided by the 5G network can be requested as a service. By way of example only, these include, but are not limited to, localization information services, group management services, and authentication and automated provisioning services. Regardless of the particular service, however, the performance of the different types of APIs (e.g., the setup time, resulting QoS, accuracy of localization, etc.) can also vary, thereby affecting the performance of the service. Such variances can occur even though the APIs are subject to the same Service Level Agreement (SLA) requirements.

Further, different vendors may (and typically do) implement their APIs differently. Because of this, however, it is possible that some APIs fail to implement important functions. This generally results in performance issues such as suboptimal connection setup. Moreover, absent a detailed analysis of a call sequence, it is extremely difficult for operators to identify which APIs may be operating optimally, which APIs are not operating optimally, and should there be an error in a call sequence, where the problem lies in which API.

Embodiments of the present disclosure address these and other issues affecting conventional systems by providing an action-space growing AI approach to optimize the application of network exposure APIs according to various KPIs. Additionally, the present embodiments provide an AI clustering method that prepares the sets of network exposure APIs for optimization. The present embodiments exploit the advantages of a per-flow analytics system by deriving desired KPIs on a per-session basis. This approach allows for the derivation of KPIs for different “dimensions” and for obtaining KPI statistical distributions, which is required for the AI method.

As defined herein, the dimensions of the KPIs refer to the aggregated parameter(s) of the KPIs. More particularly, the present embodiments obtain the KPIs on a per-flow basis in a per-flow analytics system. The per-flow KPIs are not stored for any appreciable length of time, but instead, are aggregated for different “parameters.” Such parameters include, but are not limited to, network node, terminal type, cell, services, network slices, and subscriber group. These “parameters” are the dimensions of the associated KPIs. The amount of aggregated data is less than if the data were not aggregated and can typically be stored for a longer amount of time and used for different analytics use cases. Regardless, however, the derived KPIs and KPI statistical distributions are used in the selection of the network exposure APIs and in the training process of the learning algorithm.

More particularly, the present embodiments categorize the network exposure APIs into a smaller number of API clusters based on the API call sequences and API parameters that yield the same or similar results and KPI values. The smaller number of API clusters are then used as “teachers” for a “curriculum” in a reinforcement learning (RL) algorithm that learns, over time, how to optimize a set of network exposure APIs.

For example, during the reinforcement learning process of the present disclosure, rewards are given to network exposure APIs according to a given set of predetermined circumstances. When the reward for a given network exposure API is high enough (e.g., the reward value reaches a predetermined threshold value), it is then considered to be an “optimized” network exposure API and is “released” to an “action space.” As defined herein, an “action space,” comprising a physical area of memory, stores one or more optimized network exposure APIs, each having an optimized call sequence that an application program can use to access network functions and parameters. Releasing the network exposure APIs from the API clusters to the action-space according to the present disclosure increases the size of the action space in relatively small increments. This controlled growth of the action-space allows the RL algorithm to explore the different states of the network exposure APIs in a reasonable amount of time.

Additionally, the RL-based approach of the present disclosure provides a policy with which application programs can use the network exposure APIs in an optimized manner that is congruent with SLA constraints. The overall output of a system configured according to the present disclosure, therefore, is a valid sequence of network exposure API calls (i.e., a call sequence) that is optimized based on a set of target KPIs that are specified by the SLA.

With the RL-based AI system provided in the present disclosure, the reward or cost function exploits the characteristics of network protocols. One such suitable protocol, for example, is HTTP; however, other network protocols are equally suitable for use with the present embodiments. In addition to the RL-based AI system provided herein, the present disclosure also provides a Planning system, as is described in more detail below.

Embodiments of the present disclosure are implemented, for example, in the NWDAF. However, the present embodiments may be implemented in other entities and per-flow analytics systems capable of deriving KPIs to different dimensions (i.e., different networks, devices, etc.). Such entities include, but are not limited to, a Management Data Analytics Function (MDAF) and/or entities in an Operational Support System (OSS). Further, as previously stated, the derived per-flow KPIs are used in the selection and training of the network exposure APIs. Thus, due to the automated process described herein, the present embodiments also output an optimized call sequence (i.e., an optimized network exposure API) for application developers that can be integrated into application code, thereby improving the original set of network exposure API calls according to the predefined KPIs (i.e., the target KPIs).

As stated above, the present embodiments provide an action-space in which the optimized network exposure APIs are maintained and accessible for use by application programs. As the number of optimized network exposure APIs sent to the action-space increases, so does the size of the action-space. However, with an increasing action-space, the selection of an optimized network exposure API can be costly in terms of time and space. Therefore, the present embodiments are specifically designed to accelerate the selection process by limiting the number of optimized network exposure APIs in the action-space. More specifically, the present embodiments provide an “AI-clustering” process in which the network exposure APIs (i.e., prior to optimization) are clustered or grouped according to achievable KPIs or SLAs. The KPIs that were derived to different dimensions are particularly used in the training and selection processes. The output of the AI-clustering process provides the curricula for a curriculum learning (CL) approach in which an AI-agent function is trained to select optimized network exposure APIs for the action space. More specifically, a “teacher” process uses selected curricula to train an AI agent function select optimized network exposure APIs from the clustered network exposure APIs for inclusion in the action space.

The embodiments of the present disclosure provide benefits and advantages that conventional systems cannot or do not provide. By way of example only, providing the optimized network exposure APIs according to the present disclosure provides users (e.g., service developers) with optimized API call sequences that can be integrated into application service programs. Knowing the optimized call sequences means that users will be able to spend their resources (e.g., costs) on a more focused list of features instead of those associated with unnecessary and/or inapplicable network exposure API sets. Additionally, in operation, the present embodiments are designed to save execution time and/or improve an achieved SLA for requested functionality.

The clustering process of the present disclosure also reduces the number of network exposure APIs to be processed, which also functions to accelerate the training process. Particularly, the clustering process is configured to group the network exposure APIs based on various subject matter and/or metrics. These include, but are not limited to, a number of input parameters in a given API call, a set of data types output by a network exposure API, a call duration of a network exposure API being executed, the number and/or type of nodes that are affected by a given network exposure API, and the sub-functions, if any, called by the API functions in a given network exposure API.

Additionally, not only does the RL process of the present disclosure provide an automated way in which to produce optimized API call sequences, but it also provides an automated way in which to maintain the optimization of the API call sequences. Such may occur, for example, whenever new API calls are identified, whenever the application software on one or more network nodes is updated, or whenever an execution time of the application software is changed. Other situations may occur whenever a standard that affects the execution of an application program and/or a network exposure API is modified. For example, standards may be modified from time-to-time to add/delete/modify one or more definitions, parameters, functions, and KPIs. In these situations, the RL process provided by the present embodiments rapidly adapts the training and selection of the optimized network exposure APIs to the API definitions, parameters, functions, and KPIs set forth in the modified standard.

As stated above, the RL-based approach of the present disclosure provides a policy that learns to use the network exposure APIs in an optimized manner that is congruent with SLA constraints. According to the present disclosure, the policy is fully transferrable across various deployments. Not only does this accelerate learning for other deployments, but it also avoids the necessity of having to start a learning phase for another deployment from scratch. Thus, the policies produced on a system according to one deployment can easily be used to “boot-strap” the learning and selection process on a system in another deployment.

Further, the reward function provided by the present embodiments is flexible. For example, the present embodiments can define rewards (both positive and negative) according to the importance of various KPIs. In one embodiment, for example, calls associated with KPIs that are deemed to be “more important” may be weighted such that a reward provided to a network exposure API in connection with that KPI is higher than a reward provided to the network exposure API in connection with a KPI deemed to be of lesser importance. According to the present disclosure, a network operator, for example, may configure the weights for the rewards associated with one or more selected KPIs.

Additionally, by using NWDAF per-flow monitoring techniques, embodiments of the present disclosure can compose adequate e2e KPIs, as opposed to those composed in counter-based monitoring techniques. Further, the per-flow monitoring techniques enable the present embodiments to derive KPIs for many different “dimensions.” Such dimensions include, but are not limited to, various devices, device types, vendors, software versions, network functions (NFs), NF instances, radio conditions, and the like.

The present embodiments also provide an automatic outlier detection function for the per-flow analytics system. This detection function helps the RL process to localize issues and to identify any differences in KPIs across specified network dimensions. Such functionality, according to the present disclosure, is especially advantageous for the RL process.

As an example, the automatic outlier detection function allows the present embodiments to focus on the data and parameters that can be used to optimize a network exposure AIP. Consider, for example, a situation where a measured KPI fails to meet a specified SLA target value. This failure can be due to dimensions that are not especially related to a call (e.g., network dimensions), but rather, are due to other dimensions such as vendor and/or location dimensions. According to the present embodiments, these “outlier” dimensioning instances can be excluded from consideration in the RL process. Such exclusions would allow the target KPIs (i.e., KPIs specified by an SLA) to be reached according to the “non-outlier” dimensioning instances, thereby facilitating, and accelerating, the optimization of the network exposure APIs. Any issues related to the “outlier” dimensioning instances (i.e., those instances where one or more monitored KPIs fail to meet or exceed their respective SLA-specified targets) are handled by a separate process.

Additionally or alternatively, a system configured according to the present embodiments can handle such “outlier” dimension-related instances to utilize an optimized network exposure API that is different than those used for “normal” dimension-related instances. By using different sets of optimized network exposure APIs for “normal” dimension-related instances and “outlier” dimension-related instances, the present embodiments provide a more optimal call sequence path than it would if it applied the same network exposure APIs to all dimension instances. Moreover, the per-flow monitoring method disclosed herein makes it possible to obtain KPI statistics and KPI values at different quantiles (e.g., 95% percentile). This is especially beneficial because the SLA target requirements are typically formulated for a percentile value.

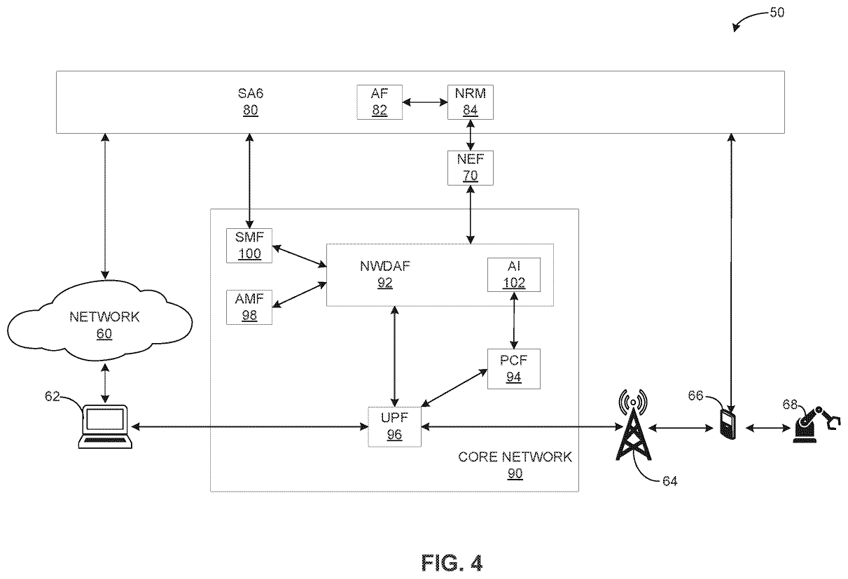

FIG. 4 illustrates a network architecture 50, as well as some of the network functions (NFs) and their interactions according to embodiments of the present disclosure. Those of ordinary skill in the art should appreciate that more or fewer components may exist.

As seen in FIG. 4, architecture 50 comprises various components including, but not limited to, a communications network 60, an SA6 layer 80, and core network (CN) 90. The communications network 60 comprises, for example, one or more public and/or private TCP/IP-based data networks that communicatively interconnect instance(s) of one or more application services executing on an application server (AS) 62 to SA6 layer 80. As is known in the art, AS 62 provides metrics and KPIs to SA6 layer 80 for delivery to a Session Management Function (SMF) 100 in CN 90.

Architecture 50 also comprises a Radio Access Network (RAN) 64 that communicatively connects one or more user devices 66, 68 to a User Plane Function (UPF) 96 in CN 90. In this embodiment, user device 66 is illustrated as being a mobile device, while user device 68 is illustrated as being a robot. However, those of ordinary skill in the art should readily appreciate that this is for illustrative purposes only, and that user devices 66, 68 may comprise other devices as needed or desired. Regardless of its implementation, however, user device 66, which communicates with user device 68, communicates various radio network and application-level KPIs to UPF 96 via RAN 64. User device 66 may also report various radio-based and usage-based KPIs to the SA6 layer 80. The KPIs may, for example, be those identified in one or more corresponding SLAs for services executing on AS 62.

The operation of the components comprising architecture 50 is analogous to the Unicast QoS monitoring functions that exploit the NWDAF functionality detailed in clause 14.3.3.4 of 3GPP TS 23.434. Particularly, an Application Function (AF) 82 (e.g., a VAL Server) initiates and forwards a SA6 resource request to a Network Resource Model (NRM) Server 84. The NRM Server 84, in turn, interacts with a Network Exposure Function (NEF) 70 to establish the API call optimization functions detailed herein. The schema for formatting and communicating messages between AF 82 and NRM 84, as well as the interactions between NRM 84 and NEF 70, already exist for Unicast QoS monitoring and are explained in subclause 14.3.3.4.1.2 of 3GPP TS 23.434. In one embodiment, the data structure communicated in the initial request from AF 82 to NRM 84 comprises, inter alia:
an Input API set with input API parameter lists; and
a reward function including state descriptors.

The NEF 70 then sends a request for API call optimization function to NWDAF 92, which in turn, requests analytics data from SMF 100 and AMF 98 for the API call optimization function. According to the present embodiments, the schema and functions associated with the communications between the NWDAF 92, AMF 98, and SMF 100 are analogous to user equipment (UE) communication analytics procedures with Nnwdaf_AnalyticsInfo_Request/Response calls between a NF and NWDAF 92 as explained in subclause 6.7.3.4 of 3GPP TS 23.288, which is incorporated herein by reference in its entirety.

As seen in FIG. 4, the NWDAF 92 is configured to collect real-time signaling data from AMF 98 and/or SMF 100, and to use the collected data to create session records and signaling related KPIs (e.g., KPIs associated with session setup, handover, session termination, session success/failure, etc.). Additionally, UPF 96 is configured to forward user plane traffic to AS 62 and/or user device(s) 66, 68 via RAN 64, and to report user plane probing data to the NWDAF 92, which is used, for example, to monitor the quality of one or more service(s) executing on AS 62.

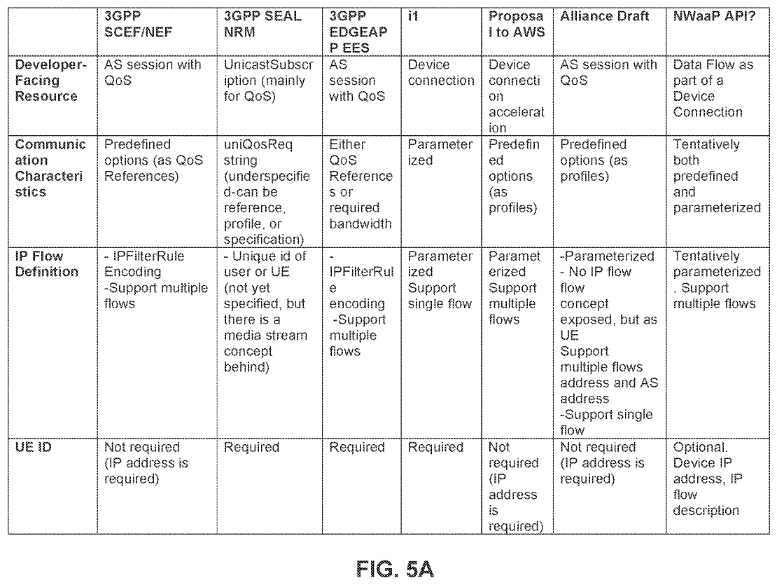

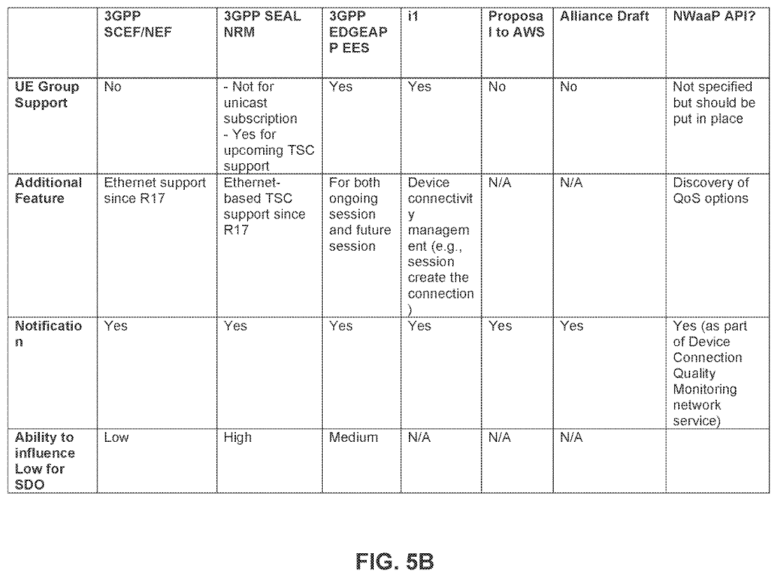

In this embodiment, NWDAF 92 also comprises an Artificial Intelligence (AI) function 102. This function, as described in more detail below, configures the NWDAF 92 to implement the present embodiments. More specifically, the AI function 102 configures NWDAF 92 to cluster the network exposure APIs, optimize the network exposure APIs, and produce one or more policies that application programs can use to select from the optimized network exposure APIs. Such policies may, for example, be configured and enforced using the Policy Control Function (PCF) 94. Additionally, based on an inspection of the network traffic (e.g., as provided by UPF 96), information received from NEF 70, SEAL requests, and a comparison between the KPIs produced during the service and a given SLA (e.g., provided by AMF 98 and/or SMF 100), the AI function 102 of the present disclosure configures the NWDAF 92 to identify one or more recommended network exposure API calls, API levels, as well as the costs that are associated with those API calls and/or API levels. Such costs may include, for example, those that are triggered by the monetization of an API, or one or more subscription fees that are charged for using various APIs. Although not limiting, such costs may be charged, for example, on a per-API basis, a per-call basis, and/or a temporal basis (e.g., based on a date and/or time of day). FIGS. 5A-5B illustrate a table indicating some exemplary network features (leftmost column) mapped to some corresponding exemplary network exposure APIs (top row).

As previously stated, embodiments of the present disclosure groups one or more network exposure APIs into clusters of network exposure APIs. Each network exposure API in a given cluster includes one or more API calls that share the same or similar parameters (i.e., overlapping parameter sets) with one or more API calls included in the other network exposure APIs of the given cluster.

Table 1 below illustrates the data types of the 3GPP NEF solution for network resource management with the AsSessionWithQoSSubscription network exposure API. As seen in Table 1 below, invoking this particular API call requires 22 different parameters that application developers must collect from various information sources and/or network elements. In some cases, the values to these parameters may be hard-coded in the application code. Thus, a sequence of API calls results in a long list of parameters to be filled in.

TABLE 1

| | | | | Applicability |
|---|---|---|---|---|
| Attribute name | Data type | Cardinality | Description | (NOTE 1) |
| self | Link | 0 . . . 1 | Link to the | |
| | | | resource | |
| | | | “Individual AS | |
| | | | Session with | |
| | | | Required QoS | |
| | | | Subscription”. | |
| | | | This parameter | |
| | | | shall be supplied | |
| | | | by the SCEF in | |
| | | | HTTP | |
| | | | responses. | |
| dnn | Dnn | 0 . . . 1 | Identifies a DNN, | |
| | | | a full DNN with | |
| | | | both the Network | |
| | | | Identifier and | |
| | | | Operator | |
| | | | Identifier, or a | |
| | | | DNN with the | |
| | | | Network | |
| | | | Identifier only. | |
| | | | (NOTE 3) | |
| snssai | Snssai | 0 . . . 1 | Identifies an S- | |
| | | | NSSAI. | |
| | | | (NOTE 3) | |
| supportedFeatures | SupportedFeatures | 0 . . . 1 | Used to | |
| | | | negotiate the | |
| | | | supported | |
| | | | optional features | |
| | | | of the API as | |
| | | | described in | |
| | | | clause 5.2.7. | |
| | | | This attribute | |
| | | | shall be provided | |
| | | | in the POST | |
| | | | request and in | |
| | | | the response of | |
| | | | successful | |
| | | | resource | |
| | | | creation. | |
| notificationDestination | Link | 1 | Contains the | |
| | | | URL to receive | |
| | | | the notification | |
| | | | bearer level | |
| | | | event(s) from the | |
| | | | SCEF. | |
| exterAppId | string | 0 . . . 1 | Identifies the | AppId |
| | | | external | |
| | | | Application | |
| | | | Identifier. | |
| | | | (NOTE 2) | |
| flowInfo | array(FlowInfo) | 0 . . . N | Describe the IP | |
| | | | data flow which | |
| | | | requires QoS. | |
| | | | (NOTE 2) | |
| ethFlowInfo | array(EthFlowDescription) | 0 . . . N | Identifies | EthAsSessionQoS_5G |
| | | | Ethernet packet | |
| | | | flows. | |
| | | | (NOTE 2) | |
| | | | (NOTE 6) | |
| enEthFlowInfo | array(EthFlowInfo) | 0 . . . N | Identifies the | EnEthAsSessionQoS_5G |
| | | | Ethernet flows | |
| | | | which require | |
| | | | QoS. Each | |
| | | | Ethernet flow | |
| | | | consists of a | |
| | | | flow identifier | |
| | | | and the | |
| | | | corresponding | |
| | | | UL and/or DL | |
| | | | flows. | |
| | | | (NOTE 2) | |
| | | | (NOTE 6) | |
| qosReference | string | 0 . . . 1 | Identifies a pre- | |
| | | | defined QoS | |
| | | | information. | |
| | | | (NOTE 5) | |
| altQoSReferences | array(string) | 0 . . . N | Identifies an | AlternativeQoS_5G |
| | | | ordered list of | |
| | | | pre-defined QoS | |
| | | | information. The | |
| | | | lower the index | |
| | | | of the array for a | |
| | | | given entry, the | |
| | | | higher the | |
| | | | priority. | |
| | | | (NOTE 4) | |
| altQosReqs | array(AlternativeServiceRequirementsData) | 0 . . . N | Identifies an | AltQosWithIndParams_5G |
| | | | ordered list of | |
| | | | alternative | |
| | | | service | |
| | | | requirements | |
| | | | that include | |
| | | | individual QoS | |
| | | | parameter sets. | |
| | | | The lower the | |
| | | | index of the | |
| | | | array for a given | |
| | | | entry, the higher | |
| | | | the priority. | |
| | | | (NOTE 4) | |
| disUeNotif | boolean | 0 . . . 1 | Indicates | DisableUENotification_5G |
| | | | whether to | |
| | | | disable QoS flow | |
| | | | parameters | |
| | | | signalling to the | |
| | | | UE when the | |
| | | | SMF is notified | |
| | | | by the NG-RAN | |
| | | | of changes in | |
| | | | the fulfilled QoS | |
| | | | situation. The | |
| | | | fulfilled situation | |
| | | | is either the QoS | |
| | | | profile or an | |
| | | | Alternative QoS | |
| | | | Profile. | |
| | | | true: the QoS | |
| | | | flow parameters | |
| | | | signalling to the | |
| | | | UE is disabled; | |
| | | | false (default): | |
| | | | the QoS flow | |
| | | | parameters | |
| | | | signalling to the | |
| | | | UE is not | |
| | | | disabled. | |
| ueIpv4Addr | Ipv4Addr | 0 . . . 1 | The Ipv4 | |
| | | | address of the | |
| | | | UE. | |
| | | | (NOTE 2) | |
| ipDomain | string | 0 . . . 1 | The IPv4 | |
| | | | address domain | |
| | | | identifier. | |
| | | | The attribute | |
| | | | may only be | |
| | | | provided if the | |
| | | | ueIpv4Addr | |
| | | | attribute is | |
| | | | present. | |
| ueIpv6Addr | Ipv6Addr | 0 . . . 1 | The Ipv6 | |
| | | | address of the | |
| | | | UE. | |
| | | | (NOTE 2) | |
| macAddr | MacAddr48 | 0 . . . 1 | Identifies the | EthAsSessionQoS_5G |
| | | | MAC address. | |
| | | | (NOTE 2) | |
| usageThreshold | UsageThreshold | 0 . . . 1 | Time period | |
| | | | and/or traffic | |
| | | | volume in which | |
| | | | the QoS is to be | |
| | | | applied. | |
| sponsorInfo | SponsorInformation | 0 . . . 1 | Indicates a | |
| | | | sponsor | |
| | | | information | |
| qosMonInfo | QosMonitoringInformation | 0 . . . 1 | Qos Monitoring | QoSMonitoring_5G |
| | | | information. It | |
| | | | can be present | |
| | | | when the event | |
| | | | “QOS_MONITORING” | |
| | | | is subscribed. | |
| directNotifInd | boolean | 0 . . . 1 | Indicates | ExposureToEAS |
| | | | whether the | |
| | | | direct event | |
| | | | notification is | |
| | | | requested. | |
| | | | true: the direct | |
| | | | event notification | |
| | | | is requested; | |
| | | | false (default): | |
| | | | the direct event | |
| | | | notification is not | |
| | | | requested. | |
| tscQosReq | TscQosRequirement | 0 . . . 1 | Contains the | TSC_5G |
| | | | QoS | |
| | | | requirements for | |
| | | | time sensitive | |
| | | | communication. | |
| | | | (NOTE 5) | |
| requestTestNotification | boolean | 0 . . . 1 | Set to true by | Notification_test_event |
| | | | the SCS/AS to | |
| | | | request the | |
| | | | SCEF to send a | |
| | | | test notification | |
| | | | as defined in | |
| | | | clause 5.2.5.3. | |
| | | | Set to false or | |
| | | | omitted | |
| | | | otherwise. | |
| websockNotifConfig | WebsockNotifConfig | 0 . . . 1 | Configuration | Notification_websocket |
| | | | parameters to | |
| | | | set up | |
| | | | notification | |
| | | | delivery over | |
| | | | Websocket | |
| | | | protocol as | |
| | | | defined in | |
| | | | clause 5.2.5.4. | |
| events | array(UserPlaneEvent) | 0 . . . N | Corresponds to | enNB |
| | | | the list of user | |
| | | | plane event(s) to | |
| | | | which the | |
| | | | SCS/AS | |
| | | | requests to | |
| | | | subscribe to. | |

NOTE 1:
Properties marked with a feature as defined in clause 5.14.4 are applicable as described in clause 5.2.7. If no features are indicated, the related property applies for all the features.
NOTE 2:
One of “ueIpv4Addr”, “ueIpv6Addr” or “macAddr” shall be included. If ipv4 or ipv6 address is provided, IP flow information shall be provided. If MAC address is provided and the AppId feature is not supported, Ethernet flow information (either “ethFlowInfo”, or if the feature EnEthAsSessionQoS_5G is supported, “enEthFlowInfo”)shall be provided. If the AppId feature is supported, one of IP flow information, Ethernet flow information (if EthAsSessionQoS_5G and/or EnEthAsSessionQoS_5G is supported) or External Application Identifier shall be provided.
NOTE 3:
The property is only applicable for the NEF.
NOTE 4:
The attributes “altQoSReferences” and “altQosReqs” are mutually exclusive. The attributes “qosReference” and “altQosReqs” are also mutually exclusive.
NOTE 5:
The attributes “reqGbrDl”, “reqGbrUl”, “reqMbrDl”, “reqMbrUl”, “maxTscBurstSize”, “req5Gsdelay”, and “priority” within the “tscQosReq” attribute may be provided only if the “qosReference” attribute is not provided.
NOTE 6:
When the Ethernet flow information is provided and, the EthAsSessionQoS_5G and EnEthAsSessionQoS_5G features are supported, either the “ethFlowInfo” or the “enEthFlowInfo” shall be provided, but not both simultenously.

To cluster the network exposure APIs, embodiments of the present disclosure input existing API call sequences with their corresponding list of parameters into a k-means clustering algorithm. In one embodiment, the parameters associated with the API call sequences specified in multiple network exposure APIs are analyzed to determine whether they are the same or similar to each other. Based on the results of this analysis, the k-means clustering algorithm clusters network exposure APIs having overlapping parameter sets into the same API cluster.

Additionally, the present embodiments allow users (e.g., network operators) to actively manage the clustering process. In one embodiment, for example, users may specify one or more constraints for the API clustering process by identifying one or more NFs and/or SEAL functions that are applicable to, or preferred for, a given scenario. In these cases, the k-means clustering algorithm would generate the clusters of network exposure APIs based on the parameter sets associated with the applicable/preferred NFs and/or SEAL functions.

In another embodiment, users can specify one or more clustering constraints based on one or more low-level and/or high-level network performance metrics and KPIs. Some example metrics are defined, for example, in Chapter 4.3.1 of 5G ACIA White Paper entitled “Exposure of 5G Capabilities for Connected Industries and Automation Applications,” which is incorporated herein by reference in its entirety. According to the present embodiments, the measured metrics and KPIs can be input into the k-means algorithm prior to the beginning of the clustering process, or they may be real-time inputs into the k-means clustering algorithm. Regardless of the particular embodiment, however, the constraints are provided directly by the users and are aligned with one or more SLAs. It should be noted, however, that the present disclosure does not require users to provide constraints for the clustering process.

The present disclosure also provides various methods for clustering the network exposure APIs. Although there may be other methods that are equally suitable, the clustering process can be accomplished using a “Planning” method or a “Monitored” method.

With the Planning method, both the starting status of the network and the resulting status of the network (i.e., before and after an API call sequence is executed) are manually defined as Planning Domain Definition Language (PDDL) problem definitions. In at least one embodiment, the network statuses are translated into logical predicates. The domain definition defines one or more actions that are performed based on the API calls of the network exposure APIs. The processing time of certain API calls can be translated into durative actions.

In the Monitoring method, KPIs are monitored and used in the clustering process. In one embodiment, the monitored KPIs depend on the SLA targets. Some examples of the types of monitored KPIs that can be utilized in the clustering process include, but are not limited to:
Connection setup time KPIs: These KPIs define an elapsed time between when a connection request is sent and when the connection is set up and available for use;
QoS KPIs: These KPIs may indicate, for example, general packet level parameters such as packet delay, loss, and jitter;
Precision KPIs: These KPIs indicate manufacturing spatial precision;
Location accuracy KPIs: These KPIs indicate the accuracy of a determined location for a device;
Congestion KPIs: These KPIs indicate situations where there are more packets arriving at a device than can be served by the device, thereby causing delay; and
Abnormal termination KPIs: These KPIs indicate unwanted and/or network-initiated session terminations because of a network issue.

As previously stated, embodiments of the present disclosure provide a per-flow analytics system that allows for obtaining KPIs e2e. For example, one embodiment of the present disclosure determines an e2e delay KPI as:

$${D}_{E N} + {D}_{C N} + {D}_{R N}$$

where:
D_{EN}=a measured delay in an external network;
D_{CN}=a measured delay in the core network; and
D_{RN}=an average delay in a radio network.
   Thus, embodiments of the present disclosure make it possible to identify different sessions and their related API call sequences and KPIs (e.g., delay), which do not meet a given e2e delay target. This is especially advantageous when compared to counter-based KPIs, which are typically obtainable only for the network domain. Further, it is currently not possible for conventional systems to obtain accurate e2e KPIs based on the values provided by counter KPIs, which provide only average values (i.e., avg delay in external net+avg delay in core network+avg delay in radio).

Moreover, the per-flow monitoring of the present disclosure also allows for deriving/obtaining KPI values from various network, devices, and/or parameters, for example, that are available to a correlated session. This provides a substantial advantage over conventional methods in which average KPI values are obtained with respect to a single dimension.

By way of example, consider a situation where, on average, an e2e target delay is met. In such situations, the sum of the target delays of each different dimension (e.g., per device vendor, location, etc.) falls within an expected delay threshold, and thus, the e2e delays are adequate and sufficient. Therefore, by using the per-flow monitoring of the present application, the total delay can be derived as well as the delay time for each component dimension. However, even though the total delay appears satisfied, it may be that the delay KPI for a given dimension (e.g., device vendor) fails to meet an expected target. In these cases, embodiments of the present disclosure may call another different network exposure API for that device vendor.

As another example, consider a situation where a given SLA target is not met when a request is served by a given NF instance. In such cases, obtaining the e2e KPIs according to the present disclosure allows a network node to determine, localize, and associate the issue responsible for not meeting the target with the given NF instance. Thereafter, API calls or policy actions may be used to facilitate the use of a different NF instance.

As stated above, the present disclosure allows for a Planning method to be used when clustering the network exposure APIs. With this method, both the starting and resultant statuses of the network may be manually defined as PDDL problem definitions, while one or more actions that can be performed based on the API calls of the network exposure APIs are defined in the domain definition. However, the detailed parameter lists can be very extensive, which leads to a high probability of error when manually defining the parameters. Automatic domain definition is one viable approach; however the detailed parameter list is also extremely difficult for an AI agent to determine. Therefore, embodiments of the present disclosure provide an RL-based approach in which the output is an optimized policy that can provide a valid sequence of API calls according to user defined KPIs.

In more detail, the present embodiments provide “action-space” learning applied for RL. As previously defined, an “action-space” is a physical memory space comprising one or more optimized network exposure APIs, each having an optimized call sequence that an application program can use to access network functions and parameters. The action-space may be defined from an initial, small set of API calls, and thereafter, “grown.” Particularly, according to embodiments of the present disclosure, agent functions executing on a network node can “grow” the action-space (i.e., update network exposure APIs already in the action-space and/or add additional network exposure APIs to the action-space) according to various curricula. This has the effect of causing API-type calls to end up with a desired goal.

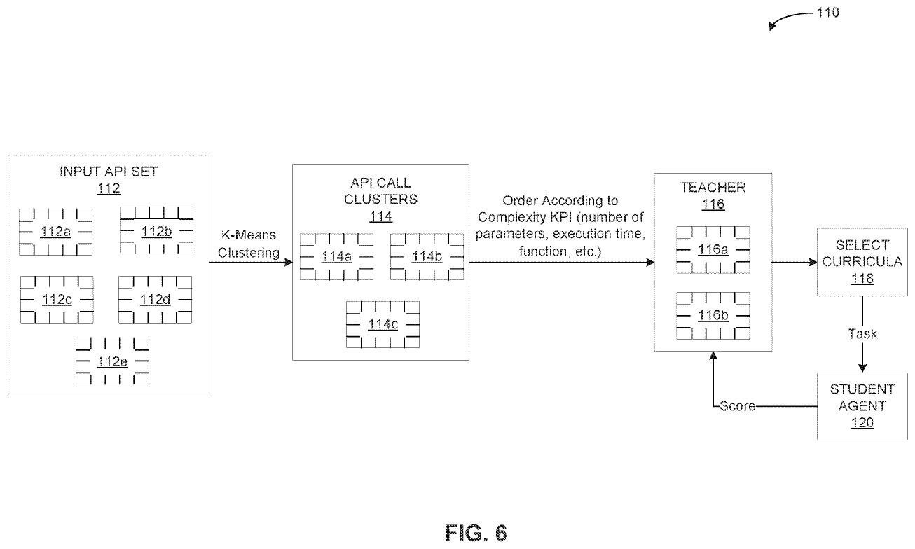

In one embodiment, the curricula used in the RL training is created by the network node based on the clustering output. FIG. 6 illustrates a pre-processing procedure 110 for generating the curricula with which to grow the action space according to at least one embodiment.

As seen in FIG. 6, pre-processing procedure 110 takes, as input, a set of one or more network exposure APIs 112. Examples of such APIs include, but are not limited to, an NEF API 112a, a SEAL API 112b, a TelcoAlliance API 112c, an AWS API 112d, and an EDGEAPP API 112e. From the network exposure APIs 112, and using k-means clustering, embodiments of the present disclosure generate a set of one or more API call clusters 114a, 114b, 114c (collectively herein, API call clusters 114). Each API call cluster 114a, 114b, 114c is an API generated to comprise a set of one or more API call sequences that may be invoked by an application program to access network service(s). Additionally, each API call cluster 114a, 114b, 114c has overlapping parameter sets.

The parameter sets associated with the API call clusters 114 are then analyzed to determine their characteristics. For example, the parameter sets of each API call cluster 114 may be analyzed and ordered based on one or more criteria. In one embodiment, the parameter sets are analyzed and ordered based on the complexity of the KPIs associated with the API call clusters 114 (e.g., the number of parameters in an API call sequence, the time taken to execute the API call sequence, the function(s) invoked by the API call sequence, and the like). The APIs 116a, 116b corresponding to the ordered parameter sets are then input into a “Teacher” function 116. Each ordered API 116a, 116b is a generated network exposure API that pertains to a different curriculum used by the RL technique of the present disclosure. The teacher function 116 then selects a particular curriculum 118 and provides one or more tasks associated with the selected curriculum to a student agent 120. Based on task execution, the student agent 120 provides a “score” (i.e., a reward value) to the teacher 116, which in turn, uses the score for subsequent selections of curricula. As seen later in more detail, the score provided by the student agent 120 indicates how well the tasks associated with the API call sequences performed for a selected curriculum.

The RL technique provided by the present disclosure is a suitable platform with which to implement network-specific and SLA-specific constraints for the action-space. Thus, according to the present embodiments, action-spaces can be designed according to a set of “must-have,” preferred, non-preferred, or unavailable NFs and SEAL services.

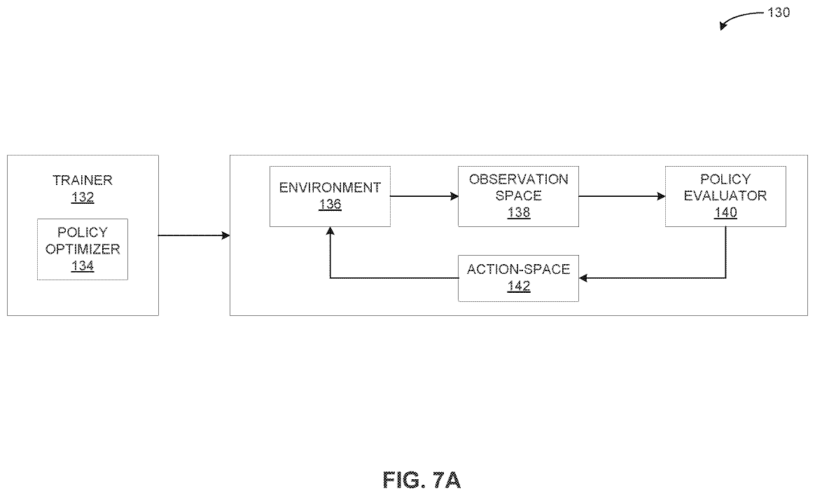

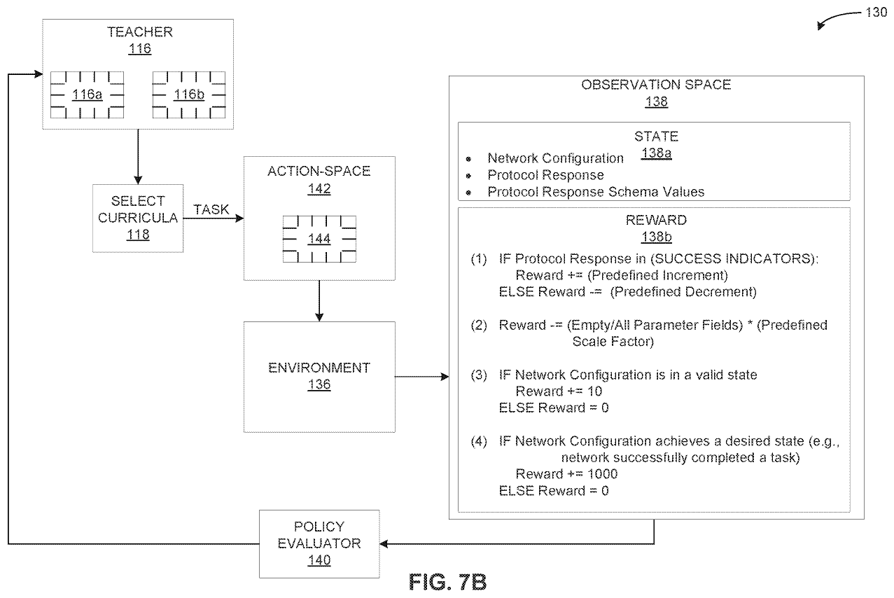

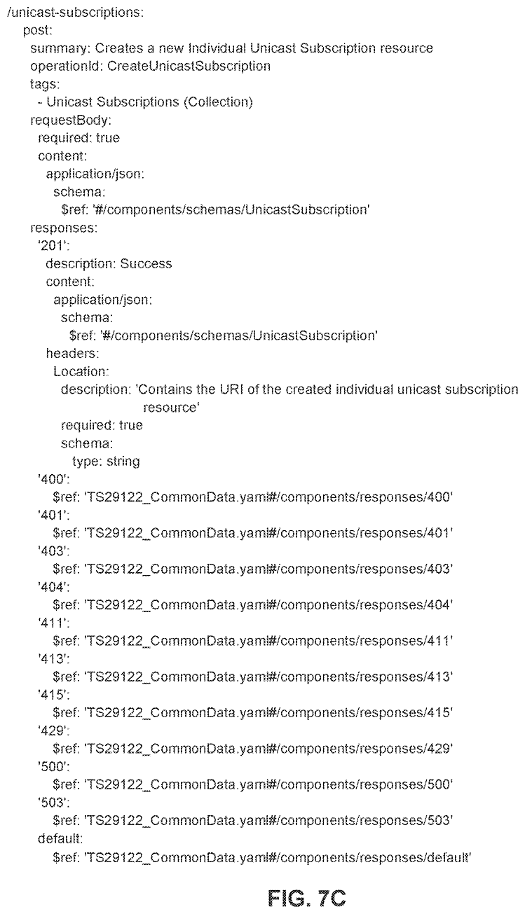

FIGS. 7A-7B illustrate an architecture 130 of a system configured to generate optimized network exposure APIs using RL according to the present disclosure. As seen in FIG. 7A, the RL technique of the present disclosure consists of 4 elements: an environment 136 in which the RL is applied, an observation space 138 which comprises the input of the RL, a policy evaluator 140 which takes actions based on the observations in the observation space 138, and an action-space 142 which comprises a set of one or more actions from which the RL can choose to use in its training.

In more detail, environment 136 is a production cell running in either a simulator, real hardware (HW), or HW configured to function in a loop or mock-up scenario. As is known by those of ordinary skill in the art, such simulators are commonly referred to as “API testing simulators.” The framework for an API testing simulator comprises an API client that is used to develop, test, share, and document APIs. For backend testing, users provide an endpoint URL for a server. During testing, the API client sends requests to that server and in return, receives responses from the server. The same or similar functionality can be accomplished using API templates and a variety of other known tools.

As seen in FIGS. 7A and 7B, the observation space 138 comprises two components-a state component 138a and a reward component 138b. The state component 138a defines the current configuration of the network together with the response values and schema values of the protocol being used in the network. 3GPP SA6 Stage 3 defines a strict, consistent method for defining HTTP responses, making the HTTP protocol a suitable candidate for state definition. One example HTTP response definition is seen in FIG. 7C. The coding example in FIG. 7C is reproduced from 3GPP TS 29.549 V17.4.0, which is incorporated herein by reference in its entirety.

The reward component 138b is a function that enforces the RL-based optimizations. In this embodiment of the present disclosure, the reward component 138a provides a reward value based on four different decision factors. The first decision factor (1) provides a reward value based on a response code of the protocol being used. If the response code indicates that an operation was successfully accomplished, the reward value is incremented by a predefined amount. If the response code indicates that the operation was not completed successfully, the reward value is decremented by a predefined amount.

By way of example, the request-response mechanism may be HTTP-based, PING-based, SIP-based, or OpenVPN-based. Other protocols are also suitable. However, given an HTTP-based reward function as an example, a response code having a value greater than 200 and less than 400 indicates that the operation was successfully completed. In these cases, the value of the reward is incremented by the predefined amount. Table 2 below provides some possible response codes for example successful GET request/response message interactions. It should be noted here that Table 2 is Table 5.14.3.3.3.1-2 of 3GPP TS 29.122, the entirety of which is incorporated herein by reference in its entirety.

TABLE 2

| | Data type | Cardinality | Remarks | |
|---|---|---|---|---|
| Request | none | | | |
| body | | | | |
| | | | Response | |
| | Data type | Cardinality | codes | Remarks |
| Response | AsSessionWithQoSSubscription | 1 | 200 OK | The subscription information related to |
| body | | | | the resource URI is returned. |
| | none | | 307 | Temporary redirection, during |
| | | | Temporary | subscription retrieval. The response |
| | | | Redirect | shall include a Location header field |
| | | | | containing an alternative URI of the |
| | | | | resource located in an alternative |
| | | | | SCEF. |
| | | | | Redirection handling is described in |
| | | | | clause 5.2.10. |
| | none | | 308 | Permanent redirection, during |
| | | | Permanent | subscription retrieval. The response |
| | | | Redirect | shall include a Location header field |
| | | | | containing an alternative URI of the |
| | | | | resource located in an alternative |
| | | | | SCEF. |
| | | | | Redirection handling is described in |
| | | | | clause 5.2.10. |

NOTE:
The mandatory HTTP error status codes for the GET method listed in table 5.2.6-1 also apply.

A response code having a value of 400 or greater, however, indicates that the operation was not successfully completed. The particular reason for the failure is encoded in the last two digits of the response code value (e.g., 4xx where ‘xx’ are the last two digits of the response code value). Regardless of the reason for the failure, however, the reward value is decremented by the predetermined amount, or in at least some alternative embodiments, not incremented.

Table 3 below provides some exemplary response code values and error handling for some example failed HTTP request/response message interactions. It should be noted here that Table 3 is Table 5.2.6-1 of 3GPP TS 29.122.

TABLE 3

| | | | Response | | |
|---|---|---|---|---|---|
| | | | Codes | Remarks | Applied |
| | Data type | Cardinality | (NOTE 1) | (NOTE 2, NOTE 4) | Methods |
| Response | ProblemDetails | 1 | 400 Bad | Incorrect parameters were | GET, |
| body | | | Request | passed in the request. | POST |
| | | | | | PUT, |
| | | | | | PATCH, |
| | | | | | DELETE |
| | ProblemDetails | 1 | 401 | The client is not authorized | GET, |
| | | | Unauthorized | as described in | POST, |
| | | | | IETF RFC 7235 [21]. | PUT, |
| | | | | | PATCH, |
| | | | | | DELETE |
| | ProblemDetails | 1 | 403 | This represents the case | GET, |
| | | | Forbidden | when the server is able to | POST, |
| | | | | understand the request but | PUT, |
| | | | | unable to fulfil the request | PATCH, |
| | | | | due to errors (e.g. the | DELETE |
| | | | | requested parameters are | |
| | | | | out of range). | |
| | | | | More information may be | |
| | | | | provided in the | |
| | | | | “invalidParams” attribute of | |
| | | | | the “ProblemDetails” | |
| | | | | structure. | |
| | | | | (NOTE 3) | |
| | ProblemDetails | 1 | 404 Not | The resource URI was | GET, |
| | | | Found | incorrect, for instance | POST, |
| | | | | because of a wrong | PUT, |
| | | | | “scsAsId” field. | PATCH, |
| | | | | | DELETE |
| | ProblemDetails | 1 | 406 Not | The content format provided | GET |
| | | | Acceptable | in the “Accept” header is not | |
| | | | | acceptable by the server. | |
| | ProblemDetails | 1 | 411 Length | The code indicates that the | POST, |
| | | | Required | server refuses to accept the | PUT, |
| | | | | request without a Content- | PATCH |
| | | | | Length header field. | |
| | ProblemDetails | 1 | 413 Payload | If the received HTTP request | POST, |
| | | | Too Large | contains payload body larger | PUT, |
| | | | | than the server is able to | PATCH |
| | | | | process, the NF shall reject | |
| | | | | the HTTP request with the | |
| | | | | HTTP status code “413 | |
| | | | | Payload Too Large”. | |
| Response | ProblemDetails | 1 | 415 | The code indicates that the | POST, |
| body | | | Unsupported | resource is in a format which | PUT, |
| | | | Media Type | is not supported by the | PATCH |
| | | | | server for the method. | |
| | ProblemDetails | 1 | 429 Too | The code indicates that due | GET, |
| | | | Many | to excessive traffic which, if | POST, |
| | | | Requests | continued over time, may | PUT, |
| | | | | lead to (or may increase) an | PATCH, |
| | | | | overload situation. | DELETE |
| | | | | The HTTP header field | |
| | | | | “Retry-After” may be added | |
| | | | | in the response to indicate | |
| | | | | how long the client has to | |
| | | | | wait before making a new | |
| | | | | request. | |
| | ProblemDetails | 1 | 500 Internal | The server encountered an | GET, |
| | | | Server Error | unexpected condition that | POST, |
| | | | | prevented it from fulfilling the | PUT, |
| | | | | request. | PATCH, |
| | | | | | DELETE |
| | ProblemDetails | 1 | 503 Service | The server is unable to | GET, |
| | | | Unavailable | handle the request. | POST, |
| | | | | | PUT, |
| | | | | | PATCH, |
| | | | | | DELETE |

NOTE 1:
In addition to the above response codes, the SCEF can also send other valid HTTP response codes, if applicable. The list of all valid HTTP response codes can be found in HTTP Status Code Registry at IANA [6].
NOTE 2:
The MIME media type that shall be used within the related Content-Type header field is “application/problem + json”, as defined in IETF RFC 7807 [8].
NOTE 3:
The information about which provided parameters are out of range shall be provided in the “invalidParams” attribute of the “ProblemDetails” structure for the API of network parameter configuration.
NOTE 4:
More information may be provided in the “detail” attribute of the “ProblemDetails” structure.

The second decision factor (2) of reward component 138b relates to a total number of parameters that are populated by a protocol request. For example, one embodiment of the present disclosure counts the cumulated number of parameters that are populated between two service requests. Then, based on a comparison of the counted number of populated parameters to one or more predetermined threshold values, the reward value is either incremented or decremented. Particularly, a positive reward value (i.e., an increment) is awarded in cases where the counted number of populated parameters meets or exceeds a predetermine threshold value, while a penalty or negative reward value (i.e., a decrement) is awarded in cases where the counted number of populated parameters does not meet or exceed a predetermine threshold value. As seen in FIG. 7B, a predefined scaling factor may be applied to the counted number of populated parameters when determining the reward value.

According to the present disclosure, the protocol requests may be simple or complex. Thus, the number of populated parameters to be counted can vary accordingly. To create complex requests, embodiments of the present disclosure (e.g., an AI-function implementing the embodiments) query the network for network-specific IDs in the system.

By way of example only, the unicast-subscription POST requests of Table 3 (i.e., a protocol request) require an HTTP body to be populated with various parameters. However, AI-function will still need to request a current VAL UE ID from the network. As seen in the following code snippet, clause 5.2.1.1 of TS 29.122, which is incorporated herein by reference in its entirety, defines some structured data types, simple data types, and enumerations applicable to various network exposure APIs discussed in the context of the present disclosure.

```
{
  “valTgtUe”: {
    “valUserId”: “string”,
    “valUeId”: “string”
  },
  “uniQosReq”: “string”,
  “duration”: “2022-06-03T07:30:02.658Z”,
  “notifUri”: “string”,
  “reqTestNotif”: true,
  “wsNotifCfg”: {
    “websocketUri”: “string”,
    “requestWebsocketUri”: true
  },
  “suppFeat”: “string”
}
```

According to the present embodiments, these data types and enumerations can be referenced from data structures defined in subsequent clauses of TS 29.122.

It should be understood, however, that the data types and/or enumerations associated with the HTTP protocol are not the only data types and enumerations suitable for use with the present embodiments. In some embodiments, for example, some or all of the data types defined in an OpenAPI Specification (e.g., OpenAPI Specification v3.1.0 dated Feb. 15, 2021) can also be referenced from data structures defined in the subsequent clauses of TS 29.122.

Additionally, the present disclosure provides a naming convention for the data types to easily differentiate them from the data types described in both TS 29.122 and the OpenAPI Specification. Particularly, the data types discussed in connection with the present embodiments are written to begin with an upper-case letter, while the parameters defined in TS 29.122 and the OpenAPI Specification are written to begin with a lower-case letter.

The third decision factor (3) considers the reward value when certain firewall rules and/or VAL grouping commands create a setup in which further reconfiguration is practically a deadlock in terms of network connectivity. These states need to be tested (e.g., by repeatedly pinging the members of a group to check if connectivity persists) and the reward value modified accordingly. For example, as seen in the embodiment of FIG. 7B, a positive (i.e., incremented) reward value is awarded if the network configuration is determined to be in a valid state. If not, however, the reward value is not incremented but instead, remains the same. Thus, in this embodiment, a penalty may be imposed either by explicitly decrementing a reward value or by neglecting to increment the reward value such that it remains the same.

In the fourth decision factor (4), a major reward is provided when a task is successfully completed (i.e., the network achieved the desired state). In these cases, a comparatively large reward (e.g., +1000 as seen in FIG. 7B) is added to the current reward value in situations where the network achieved a desired, valid state. In situations where the network did not achieve a desired, valid state, no reward increment is given. Instead, the current reward value remains at its current value.

Regardless of the particular reward value (i.e., increment, decrement, no-change), however, the reward value is provided to the policy evaluator 140. The policy evaluator 140, in turn, generates a policy for RL and provides that policy to the teacher function 116. As stated previously, the teacher function 116 modifies one or more ordered APIs 116a, 116b according to the policy and selects one or more curricula 118. Each API 116a, 116b may be associated with a different curricula. Teacher 116 then provides one or more tasks associated with the selected curriculum, along with an optimized network APIs 144, to action-space 142. The optimized network APIs 144 are the physical output of the present embodiments and are used in environment 136. Specifically, each optimized network API 144 comprise optimized call sequences for application developers that can be integrate into application code, thereby improving the original set of API call sequences according to the predefined KPIs monitored and obtained by the present disclosure.

Given the above, the present disclosure provides multiple useful scenarios for optimizing network exposure APIs. For example, in one embodiment, applying either a planning technique or a RL technique makes it possible to define various goal and/or reward functions. By way of example, the reward functions provided by the reward component 138b can be optimized on one or more of:
Minimizing the number of API type calls: This is where the API calls are intended to be used from a same family of network exposure APIs, or due to specified constraints, from a preferred family of network exposure APIs. For example, in cases where a user does not have to pay to use network exposure APIs related to NEF, SEAL, and/or Amazon API support, embodiments of the present disclosure can implement RL training such that only the network exposure APIs for SEAL are optimized for the user.
Minimizing the number of API calls: In this case, the RL techniques described herein will prefer to base training on a network exposure API that is deemed to be more efficient or that solves multiple issues in another API family.
Minimizing the execution time: In cases where one or more measurements of the processing time needed for various network exposure API calls to take effect are available, the RL techniques of the present disclosure can include those measurements in the optimization process.

In other embodiments, alternate ML techniques can be employed in lieu of, or in addition to, the RL techniques. For example, if transfer learning (TL) is deemed useful and provides a similar output, than TL techniques can be used instead of, or in lieu of, the RL techniques described herein. For cases in which there are a variety of unknown rewards functions, embodiments of the present disclosure can be configured to implement an inverse RL problem to automatically determine the rewards, or an imitation learning problem to apply existing expert knowledge.

In another embodiment, the present disclosure is configured to map reward functions to protocol response codes. Particularly, the network protocol(s) considered in the present disclosure can either be mapped automatically or manually for reward functions. For example, most of the protocols a state-machine have a limited number of states and transitions and are well-documented (e.g., see protocol specifications such as those provided by IEEE, 3GPP, or RFC). Thus, such mapping can be performed manually within a reasonable amount of time and with reasonable effort.

For automated protocol state to reward function mapping, protocol analyzer functions such as those provided by WIRESHARK or HTTP debuggers, can be used in conjunction with the present embodiments. For example, WIRESHARK includes a description of a given protocol in LUA format as well as a verbose description of the protocol states with response codes. In these embodiments, an automatic parser for the LUA descriptions that prepares a reward function can be used to map protocol states to different reward functions within a reasonable amount of time and with a reasonable amount of effort. Additionally, or alternatively, HTTP debuggers may be used in some embodiment to debug and build state-machines for HTTP related protocols such as HTTP 2.0, QUIC, and HTTP 3.0, for example.

In one embodiment, a fully automated solution can be based on Natural Language Processing (NLP). In such cases, implementing NLP functions on a protocol specification text provide a semi-automated generation of protocol implementations.

In another embodiment, the third decision factor in the reward component 138b, which checks the validity of a certain action of an AI-agent (i.e., whether the network configuration is/is not in a valid state), is optional. In cases where the third decision factor is not used at all, it is still possible to determine whether the network configuration is in a valid state in an “exploration phase.” The state space is somewhat limited in this application field, but to solve the late reward issue of RL it is preferred to provide small rewards during the exploration phase as well. According to the present embodiments, the validity of the state in a network domain can be covered with a small set of test types related to one or more of:
connectivity monitoring (e.g., SNMP, simple port testers, ping);
network performance testing in cases associated with Network Resource Management activities;
functional testing; and
routing testing.
   Running some or all of these tests after each step in the RL training process, or continuously, is not processing heavy.

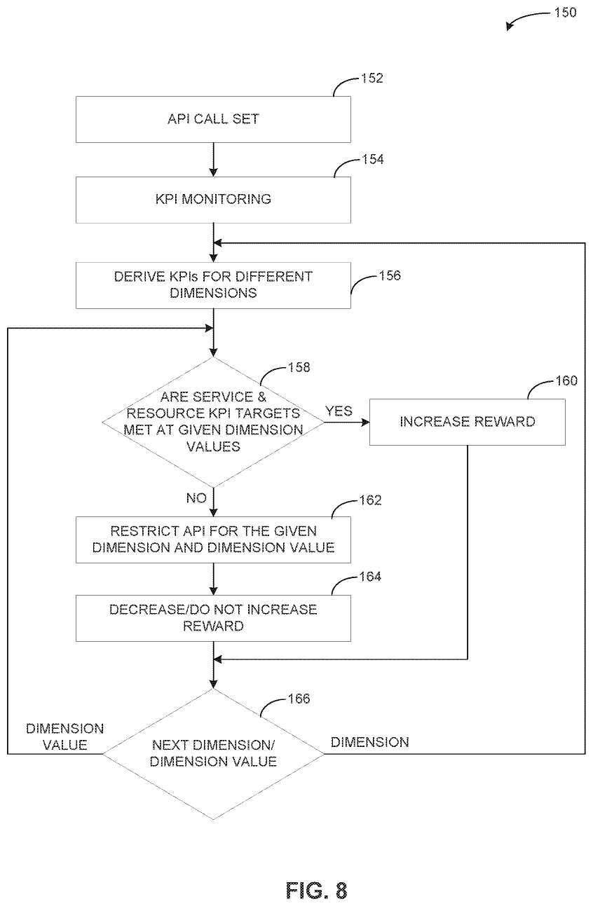

FIG. 8 is a flow diagram illustrating an exemplary method 150 for monitoring service and resource KPIs, and for using those KPIs in a ML process to train and optimize network exposure APIs according to embodiments of the present disclosure. As previously stated, embodiments of the present disclosure are described in the context of RL techniques and HTTP; however, this is merely for illustrative purposes. Other ML techniques and/or protocols are equally as suitable for use in connection with the present disclosure.

Method 150 “begins” with obtaining an API call set (box 152). The API call set may be, for example, the network exposure APIs previously described. Method 150 also calls for monitoring one or more KPIs, such as those associated with the network and/or user traffic (box 154). Next, method 15 derives KPIs for different network and device dimensions, as well as obtains KPI statistical distributions (box 156). So derived, method 150 then determines whether the KPIs meet one or more predefined service and/or resource target values for a given dimension values (box 158). Provided the derived KPIs meet or exceed the one or more predefined service and/or resource target values for the given dimension, reward component 138b increases the reward (box 160). If not, however, reward component 138b restricts the API for the given dimension and/or dimension values (box 162) and decreases (or alternatively, does not increase) the reward (box 164). Regardless of whether the KPIs do or do not meet the appropriate predefined KPI target values, however, method 150 determines whether there are additional dimensions or dimension values to process (box 166) and repeats processing based on that decision.

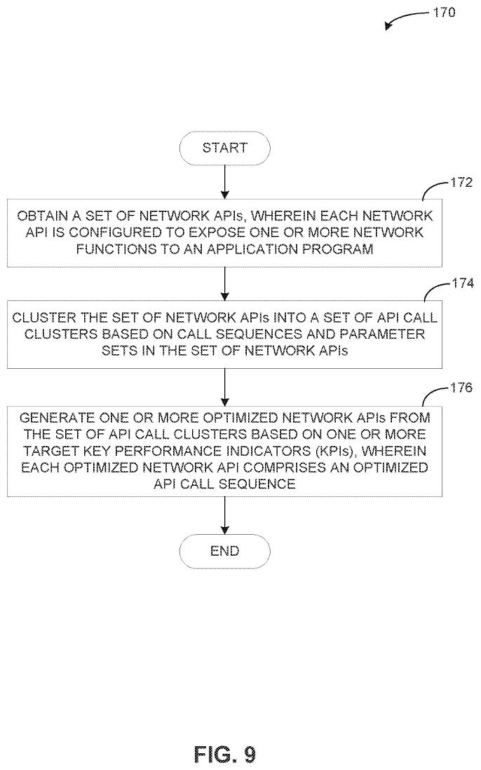

FIG. 9 is a flow diagram illustrating a method 170 for optimizing network exposure APIs according to embodiments of the present disclosure. In this embodiment, an AI-agent executing on an NWDAF implements method 170 to cause the NWDAF to perform these functions. However, it should be understood that the AI-agent may execute on other network nodes, such as an NEF, for example.

As seen in FIG. 9, method 170 obtains a set of network APIs (box 172). Each network API is configured to expose one or more network functions to an application program. Method 170 then clusters the set of network APIs into a set of API call clusters based on call sequences and parameter sets in the set of network APIs (box 174). Once clustered, method 170 generates one or more optimized network APIs from the set of API call clusters based on one or more target KPIs (box 176). As previously described, each optimized network API is generated to comprise an optimized API call sequence for integration into and/or use by an application program.

In one embodiment, the network analytics data is obtained responsive to receiving an API call optimization request. For example, in one embodiment, the network analytics data is obtained from a Session Management Function (SMF). In another embodiment, the network analytics data is obtained from an Access & Mobility Management Function (AMF). Further, in at least some embodiments, user plane KPIs are obtained from a User Plane Function (UPF).

In some aspects, the network analytics data includes KPIs that are being monitored. For example, such KPIs may comprise one or more of:
a connection setup time KPI defining a time between when a connection request is sent and a time when the connection is set up and available;
a Quality of Service (QoS) KPI defining one or more packet-level data parameters;
a precision KPI defining a manufacturing spatial precision;
a location accuracy KPI indicating an accuracy of localization of a device;
a congestion KPI indicating that a number of arriving data packets is greater than a number of data packets that can be served; and
an abnormal termination KPI indicating the termination of an unwanted session or a network-initiated termination of a session.

In one embodiment, the KPIs that are being monitored are specified in a Service Level Agreement (SLA).

Additionally, in one embodiment, the KPIs are obtained on a per-flow basis.

In at least one embodiment, the KPIs are specific to one or both of a network and a device that are correlated to a session associated with the flow.

Further, in one embodiment, one or more of the APIs in each API call cluster comprises overlapping parameters and/or one or more overlapping call sequences.

In one embodiment, the set of network APIs are clustered using a k-means clustering algorithm. Additionally, in one embodiment, the set of network APIs are clustered according to one or more constraints defined by a Service Level Agreement (SLA).

In one embodiment, the set of constraints is defined by one or more Network Functions (NFs), Service Enable Architecture Layer (SEAL) functions, network level performance metrics, and/or KPIs.

In one embodiment, the optimized API call sequence is optimized using a Planning Domain Definition Language (PDDL) having one or more problem definitions and one or more domain definitions. In such embodiments, the one or more problem definitions define a network status for the network, and the one or more domain definitions identify actions that are performed according to a call sequence in an API call cluster. Additionally, the network status defines one or both of a beginning status of the network prior to execution of the call sequence in the API call cluster, and a resultant status of the network after the execution of the call sequence in the API call cluster.

In one embodiment, generating the one or more optimized network APIs comprises generating a policy for using the optimized API call sequence based on the one or more target KPIs.

In one embodiment, the one or more optimized network APIs are comprised in variable-sized action space.

In at least one embodiment, the one or more optimized network APIs are generated using a reinforcement learning (RL) technique. In such embodiments, the RL technique defines an environment space defining an environment in which the one or more optimized network APIs are used, an observation space defining a state component and a reward component, an action space defining the one or more optimized network APIs, and a policy evaluator configured to perform one or more RL actions based on the state component and the reward component defined in the observation space.

In one embodiment, the environment space comprises one of an API testing simulator, hardware circuitry disposed in a production cell, and hardware circuitry disposed in a test cell.

In one embodiment, the state component defines a current network configuration and one or more protocol parameters of a protocol used in the environment.

In one embodiment, the reward component defines a function that trains the network node to generate the optimized network API.

In such embodiments, the reward component sets a reward value for training the network node based on whether a protocol response message indicates that a function defined in an optimized network API succeeded or failed, a number of protocol parameters provided by the function in response to one or more protocol requests, whether the current network configuration is in a valid state, and whether the network successfully completed a task associated with the optimized network API.

In one embodiment, the current network configuration is in a valid state is determined based on a result of one or more of connectivity monitoring, network performance testing, functional testing, and routing tests.

In one embodiment, the one or more optimized network APIs are optimized for one or more of a minimized number of API type calls, a minimized number of API calls, and a minimized execution time.

In one embodiment, method 170 is implemented at a Network Data Analytics Function (NWDAF). In another embodiment, however, method 170 is implemented at a Management Data Analytics Function (MDAF). In yet another embodiment, method 170 is implemented at an Operational Support System (OSS) entity.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

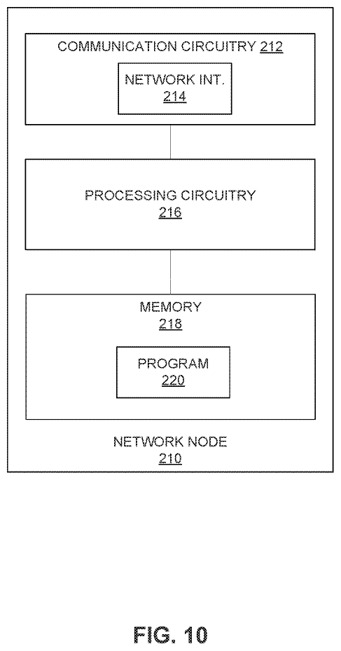

FIG. 10 illustrates some of the main functional components of a network node 210 configured according to one embodiment of the present disclosure. As previously described, network node 210 may be a NWDAF 26 or a MDAF 32, as previously described, but is not limited to those nodes. Other nodes in network 12 and/or an OAM-based computing device may be configured to operate according to the embodiments described herein. As seen in FIG. 10, network node 210 comprises communication circuitry 212, processing circuitry 216, and memory 218.

The communication circuitry 212 comprises network interface circuitry (NIC) 214. In one or more embodiments, the NIC 214 comprises network interface circuitry that configures network node 210 for communication with one or more other nodes, core network nodes, and or external systems, such as an OAM entity, for example. The network interface circuitry may, for example comprise an Ethernet interface, optical network interface, or a wireless interface.

The processing circuitry 216 comprises one or more microprocessors, hardware, firmware, or a combination thereof that control the overall operation of the network node 210. The processing circuitry 216 can be configured by software to perform one or more of the methods herein described including methods 150 and 170 seen in FIGS. 8 and 9, respectively.

Memory 218 comprises both volatile and non-volatile memory for storing computer program code and data needed by the processing circuitry 216 for operation. Memory 218 may comprise any tangible, non-transitory computer-readable storage medium for storing data including electronic, magnetic, optical, electromagnetic, or semiconductor data storage. Memory 218 stores a computer program 220 comprising executable instructions that configure the processing circuit 216 in the network node 210 to perform one or more of the methods herein described including methods 150 and 170 seen in FIGS. 8 and 9, respectively. A computer program 220 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 220 for configuring the processing circuitry 216 as herein described may be stored in a removable memory, such as a portable compact disc, portable digital video disc, or other removable media. The computer program 220 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments of the present disclosure further include a carrier containing such a computer program 220. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by network node 210. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

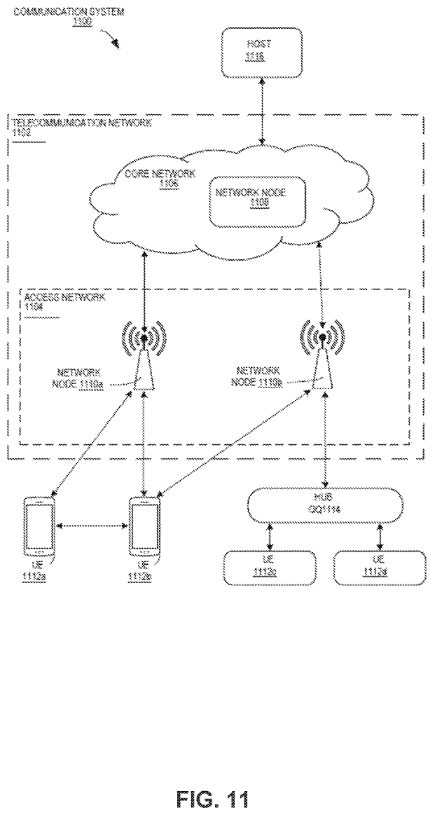

FIG. 11 shows an example of a communication system 1100 in accordance with some embodiments. In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular, if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

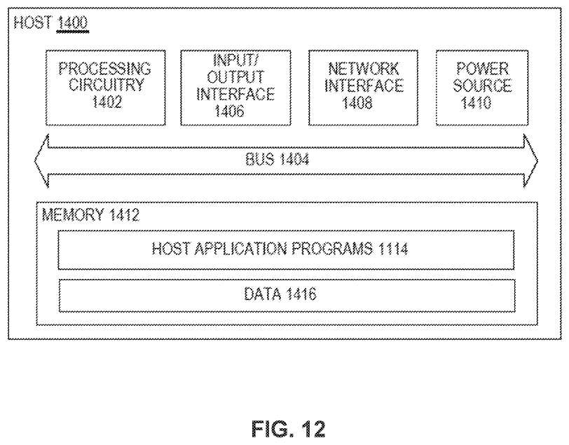

FIG. 12 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

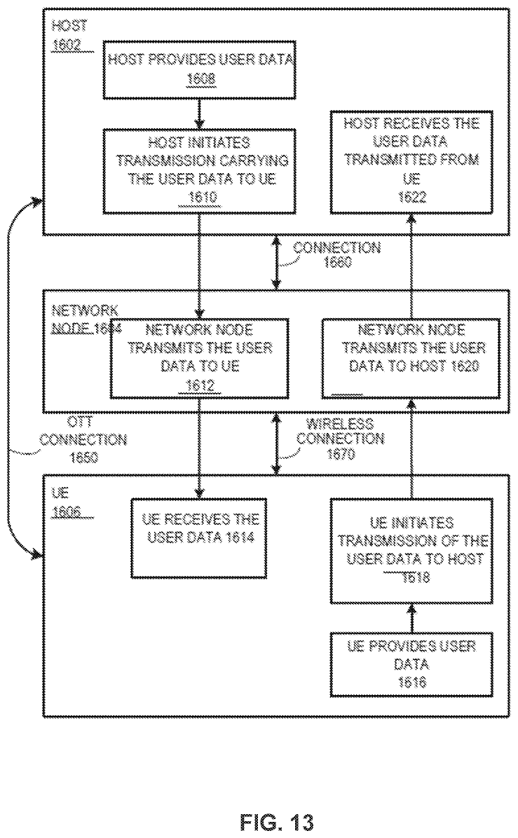

FIG. 13 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11), network node (such as network node 1110a of FIG. 11), and host (such as host 1116 of FIG. 11) discussed in the preceding paragraphs will now be described with reference to FIG. 13.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may enable the UE to adapt faster to radio conditions and realize higher data throughput. In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The embodiments described herein may, of course, be carried out in other ways than those specifically set forth herein without departing from essential characteristics of the disclosure. The present embodiments are therefore to be considered in all respects as illustrative and not restrictive, and all changes coming within the meaning and equivalency range of the appended claims are intended to be embraced therein.

1-36. (canceled)

37. A method, implemented in a network node, for optimizing network exposure Application Programming Interfaces (APIs), the method comprising:
obtaining a set of network APIs, wherein each network API is configured to expose one or more network functions to an application program;
clustering the set of network APIs into a set of API call clusters based on call sequences and parameter sets in the set of network APIs; and
generating one or more optimized network APIs from the set of API call clusters based on one or more target Key Performance Indicators (KPIs), wherein each optimized network API comprises an optimized API call sequence.

38. The method of claim 37, further comprising obtaining network analytics data responsive to receiving an API call optimization request.

39. The method of claim 38, wherein the network analytics data is obtained from a Session Management Function (SMF).

40. The method of claim 38, wherein the network analytics data is obtained from an Access & Mobility Management Function (AMF).

41. The method of claim 38, further comprising obtaining user plane KPIs from a User Plane Function (UPF).

42. The method of claim 38, wherein the network analytics data includes KPIs that are being monitored, the KPIs comprising one or more of:
a connection setup time KPI defining a time between when a connection request is sent and a time when the connection is set up and available;
a Quality of Service (QoS) KPI defining one or more packet-level data parameters;
a precision KPI defining a manufacturing spatial precision;
a location accuracy KPI indicating an accuracy of localization of a device;
a congestion KPI indicating that a number of arriving data packets is greater than a number of data packets that can be served; and
an abnormal termination KPI indicating the termination of an unwanted session or a network-initiated termination of a session.

43. The method of claim 42 wherein the KPIs that are being monitored are specified in a Service Level Agreement (SLA).

44. The method of claim 42, wherein the KPIs are obtained on a per-flow basis.

45. The method of claim 43, wherein the KPIs are specific to one or both of a network and a device that are correlated to a session associated with the flow.

46. The method of claim 37, wherein one or more of the APIs in each API call cluster comprises overlapping parameters and/or one or more overlapping call sequences.

47. The method of claim 37, wherein the set of network APIs are clustered using a k-means clustering algorithm.

48. The method of claim 37, wherein the set of network APIs are clustered according to one or more constraints defined by a Service Level Agreement (SLA).

49. The method of claim 48, wherein the set of constraints is further defined by one or more:
Network Functions (NFs);
Service Enable Architecture Layer (SEAL) functions;
network level performance metrics; and/or
KPIs.

50. The method of claim 37, wherein the optimized API call sequence is optimized using a Planning Domain Definition Language (PDDL) having one or more problem definitions and one or more domain definitions.

51. A network node for optimizing network exposure Application Programming Interfaces (APIs), the network node being configured to:
obtain a set of network API, wherein each network API is configured to expose one or more network functions to an application program;
cluster the set of network APIs into a set of API call clusters based on call sequences and parameter sets in the set of network APIs; and
generate one or more optimized network APIs from the set of API call clusters based on one or more target Key Performance Indicators (KPIs), wherein each optimized network API comprises an optimized API call sequence.
